(19) United States
(12) Patent Application Publication
(10) Pub. No.: US 2024/0169217 A1
(43) Pub. Date: May 23, 2024

(54) POOLING AND RANKING

(71) Applicant: Freshworks Inc., San Mateo, CA (US)

(72) Inventors: Rahul Kumar SHARMA, Gurgaon (IN); Swaminathan PADMANABHAN, Chennai (IN)

(73) Assignee: Freshworks Inc., San Mateo, CA (US)

(21) Appl. No.: 18/058,102

(22) Filed: Nov. 22, 2022

(51) Int. Cl. G06N 5/022; G06N 5/025

(52) U.S. Cl. CPC G06N 5/022; G06N 5/025

(57) ABSTRACT

Lead pooling and ranking includes implementing a pooling technique enhancing and optimizing lead scoring machine learning techniques for a set of leads. Lead pooling and ranking also includes generating a lead score for each configured rule, and combining one or more machine learning (ML) scores and one or more rules based scores to create a unitary score for each corresponding lead in the set of leads. Lead pooling and ranking further includes generating a rank and rating for each lead in the set of leads.

### FIELD

The present invention relates to pooling and ranking, and more particularly, to pooling and ranking digital leads.

### BACKGROUND

Lead scoring systems categorize and sort prospective customers (i.e., leads or sales opportunities) based on an estimated probability of conversion. Leads, for the purposes of explanation, is a collection of data that is used by a user to connect with an end consumer.

A simple lead scoring enables categorizing of and sort prospective leads or based on an estimated probability of conversion. The goal is to get leads into a pipeline. Once a substantial number of leads have been obtained, the next goal is to focus on the prospecting leads with a higher conversion probability, which is where lead scoring plays an important role.

By eliminating leads with poor conversion rates, only leads with high conversion rates are shown. Thus, an alternative technique for multi-tenant lead scoring, which addresses multiple specific problems (including optimization for small accounts, remove scoring requirement for defined rules, combine ML and explicit rules efficiently, generate ranks for all leads, etc.) in the CRM lead space may be beneficial.

### SUMMARY

Certain embodiments of the present invention may provide solutions to the problems and needs in the art that have not yet been fully identified, appreciated, or solved by current lead scoring technologies. For example, some embodiments of the present invention pertain to multi-tenant lead scoring addressing multiple problems that exists in customer relation management (CRM) systems.

In an embodiment, a lead pooling and ranking system includes at least one processor and memory comprising a set of instructions. The set of instructions is configured to cause the at least one processor to execute implementing a pooling technique enhancing and optimizing lead scoring machine learning techniques for a set of leads, and generating a lead score for each configured rule. The set of instructions is further configured to cause the at least one processor to execute combining one or more machine learning (ML) scores and one or more rules based scores to create a unitary score for each corresponding lead in the set of leads, and generating a rank and rating for each lead in the set of leads.

In another embodiment, a method for lead pooling and ranking includes implementing a pooling technique enhancing and optimizing lead scoring machine learning techniques for a set of leads, and generating a lead score for each configured rule. The method also includes combining one or more machine learning (ML) scores and one or more rules based scores to create a unitary score for each corresponding lead in the set of leads, and generating a rank and rating for each lead in the set of leads.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a method for performing multi-tenant lead scoring on an end-to-end system, according to an embodiment of the present invention.

FIG. 2 is a flow diagram illustrating a method for pooling and ranking of a set of leads, according to an embodiment of the present invention.

### DETAILED DESCRIPTION OF THE EMBODIMENTS

Some embodiments generally pertain to a lead pooling and ranking system built with multiple modules. For example, the lead pooling and ranking system includes a pooling module, a score generation module, a machine learning (ML) and rule based module, and a rankings module.

Pooling is a technique that enhances and optimizes lead scoring ML techniques. A lead scoring system works well with larger businesses because ML models can be leveraged and built on company's own data. For example, the patterns from agent-customer historical intersection can be captured and ML based models can be used to predict the likelihood of a lead becoming a customer for a given set of leads.

The problem arises when lead scoring is enabled for smaller companies which don't have enough data (i.e., history of agent-customer interactions). The rule-based lead scoring will be the only option left in the lack of the historical data.

### Pooling

Some embodiments pertain to a pooling technique that removes this constraint by enabling a ML approach for small accounts. The pooling module works in two phases.

In the first phase, the pooling module assigns a category to an entity (for which the lead scoring feature is to be enabled). The following are the different categories computed for a given entity. For example, an indecisive category is used to tag a very low strength objective and represents the need of more data to make a decision about the model building. Blurry category is used tag a small or mid strength objective and can be a good start to decide about the model building. Blurry category also has few subcategories to help with deciding whether pooling is required or not. Blurry category may include tiny accounts, small accounts with a low lead conversion rate, large accounts with low conversion rates, small accounts with high conversion rates, and accounts with no data. Finally, limpid category represents a clear go-ahead about the ML model. Limpid category also has few subcategories to help with the deciding whether the pooling is required or not. Limpid category may include large accounts with a high conversion rate, small accounts with a high conversion rate, large account with a very high conversion rate. For purposes of explanation, low lead conversion rate include less than 40 percent conversion rate, high conversion rates include 60 percent conversion rate, and very high conversion rates include a 80 or 90 percent conversion rate.

In the second phase, the pooling module decides if data pooling is required for a given account with the help of categories and subcategories mentioned above. The global/industry/region/country specific features are calculated with the concept of pooling as more data is pooled (or gathered) from similar sets of accounts to build a robust and correct ML model. The features are computed in such a way that there is no direct data sharing or PI exchange happening across these businesses. The features are computed on the basis of categories and associated sub-categories, e.g., tiny subcategory in blurry category surely used pooling at industry/global level.

In one example of pooling, let's say a given entity belongs to SAAS vertical and pooling is used for this account. Several interaction based features/priors are constructed from thousands of similar account's data belonging to SAAS vertical and a vertical/global model is trained. For training, xgBoost and balanced random forest is used.

The constructed ML models are then used to predict lead scores for a given entity.

### Score Generation

Regarding score generation, a provision is given to configure different rules for leveraging rules based lead scoring module. Generally, an account admin configures different rules and also configures a corresponding score for each of the rules. The score generation module however removes the necessity of providing point based scores. The score generation module may use a positive and negative rules (without predetermined weights) in a priority order configured on product UI.

The score generation module further uses a mathematical algorithm to generate an overall max weights account one can have for all the configured rules. The max function is a function of categories/sub-categories defined above. The max weight is an interval (MIN, MAX), which depend on the category (e.g., limpid, blurry or indecisive). This is a configurable parameter and depends on the ML performance in these categories. Greater ML performance (AUC) means less max weights for explicit rules. Further, the exact max weight total_weight (e.g., a value between MIN and MAX) is a function of #rules configures by the account's admin. More number of rules means more total weight needs to be assigned. It is calculated as follows.

total_weight=min[MIN+max(#positive_rules,#negative_rules), MAX] Equation (1)

Then corresponding to each configured positive/negative explicit rule, score generation module assigns a weight. The weight for each rule depends on two things—a priority order and a polarity of the rule. Polarity means either positive or negative.

With a ML-based approach, 3 types of models are trained. This includes a fit model, an engagement model, and a semantic model for a given entity. Eventually, all three models are combined and a single AI score is provided to each lead.

With a rules-based approach, a set of rules (e.g., email type, country, state of the lead, annual revenue of the lead's employer, company size of the lead, number of replied emails, etc.) are configured within the system.

Most of existing CRM providers require a list of rules along with a positive or negative point base score (e.g., a corporate email may have +5 weight, whereas a country will have −10 weight). With the embodiments described herein, this point base score mechanism is not required. Instead, a set of positive and negative rules (without predetermined weights) are set in a priority order.

Some embodiments may use a mathematical algorithm to assign different weights in a more optimal way so that this automated weight generation lead scoring module performs better than the manual assigned weight lead scoring. Essentially, the score generation module provide two steps automated weight computation for a given business.

First, the score generation module determines how much total weight needs to be assigned to all rules. For example, the overall weight is a function of ML model performance and number of configured rules. For instance, with a higher ML performance, the rules based lead scoring contribution is lower. Conversely, with a lower ML performance, the rules based lead scoring contribution is higher. Further, more rules means that the total weight needs to be assigned to all explicit rules. The total weight may be calculated as

Total_weight=min[min_weight_for_rules+max(#positive_rules,#negative_rules), max_weight_for_rules] Equation (2)

Next, the score generation module determines how to compute weight for individual configured rules. For example, the score generation module has an in-place algorithm to automatically compute a weight for each of the positive and negative explicit rules on the basis of their priority on the product configure system.

### Algorithm

In some embodiments, the above calculated total_weight is first distributed amongst a larger set of the explicit rules (set−LSR) using the method described below. In these embodiments, any rules (including its values), which have a high priority, have more weight. The rules, which have lower priority, have a lower weight. All values in a given rule will have the same weight.

How to divide total_weight to LSR in a priority order? For instance, the weight needed to assign to rule number n+1 is based on the weight assigned to rule number n because rule number n+1 has a higher priority than rule number n. Again, this assigned weight is increasing uniformly with the rule order from bottom to top. Simply put, the local weight needed to get for rule number k is k*w.

To get the total weight, all such weights are summed to get total_weight. Thus, the total weight will be:

1*w+2*w+ . . . +(#LSR)*w=total_weight=>w(1+2+ . . . +#LSR)=total_weight=>w*[#LSR(#LSR+1)/2]=total_weight=>w=2*total_weight/[#LSR(#LSR+1)]

where #LSR is the total number of configured rules in LSR. Thus, the weight assigned to kth rules is defined as

wₖ=w*k=2*k*total_weight*/[#LSR(#LSR+1)] Equation (3)

The smaller set (set−SSR) copies the individual assigned rules' weights (i.e., top to bottom) from LSR.

In other words, if w1, w2, . . . wn is the weight associated with 1, 2, . . . n rules in LSR, the rules 1, 2, . . . m in SSR may also have weights w1, w2, . . . wm from top to bottom. In this example, n>=m.

Any rule (and all its values), which have higher priority, may have more weight. The rules, which have less priority, may have less weight. All values in a given rule will have the same weight. The calculated total_weight in above step will be distributed amongst a larger set of the explicit rules (e.g., set−LSR). The weight assigned to kth rules in LSR can be calculated by the formula:

$$wk = w * k = 2 * k \frac{total\_weight}{\# rules\_in \_lsr ( \# rules\_in \_lsr + 1 )} \qquad Equation ( 4 )$$

After that, the score generation module computes weights for individual configured rules. For example, the smaller set (e.g., set−SSR) will copy the individual assigned rules' weights (top to bottom) from LSR. In other words, if w₁, w₂, . . . wₙ is the weight associated with 1, 2, . . . n rules in LSR, the rules 1, 2, . . . m in SSR may also have weights w1, w2, . . . wₘ from top to bottom. In this example, n>=m.

### ML and Rule Based

The ML and rule based module has a provision to use both—ML and rules based lead scoring together in a more optimal way. Initially for each of the leads, the system match all the configured rules and find a match score. Then the system generates ML based score using different ML models. Eventually it combines both kinds of scores together for each lead and shows a final score on the product UI.

In some embodiments, the ML and rule based module uses an optimization technique that combines ML base scores and rules based scores to a single score corresponding to each of the leads in the account.

In an embodiment, the ML and rule based module matches all the rules with the given contact attributes and calculate the matched score as

sᵣ=(total matched positive weight−total matched negative weight) Equation (5)

The ML and rule based module may then generates ML based score using 3 different ML models.

s_{ML}=(w₁*static_model_score)+(w₂*interest_model_score)+(w₃*semantic_model_score) Equation(6)

where, w₁, w₂, and w₃ are predetermined weights and represent the contributions from static, interest, and semantic models, respectively. The final score may then be shown on the product user interface (UI), and is calculated as follows.

s=s_{R}+s_{ML}, s=s.clip(0,1) Equation (7)

### Rankings Module

The ranking module ranks all the available leads on the basis of their final scores (Explicit+ML Scores) and also generates customer ratings (from 1 to 5) for all of these leads. The ranks and customer rating are derived on the basis of scores distribution generated from the historical validation data set by using the built model. The sales owners can tag these leads in ‘hot’, ‘warm’, ‘cold’ or ‘likely to close’ categories on the basis of final score or ratings.

The ranking module inputs a final score s as an input and generate two outputs. For example, ranking module maps a score to a rank as defined below.

rank=rank_start_point+(rank_end_point−rank_start_point)*[(score−score_start_point)/(score_end_point−score_start_point)] Equation (8)

In this embodiment, rank_start_point=0 and rank_end_point=97. In this example, a lead may have a score ranging from 0-97 on the UI. The value of score_end_point and score_start_point is computed from the validation dataset used during the ML model training.

Ranking module may also provide a rating from 1 star to 5 star for each lead. The lead rates are defined in such a way that each rate would have a similar number of leads. The user of the system may have a provision to sot, categorize (between hot leads, warm leads, cold leads, or likely to close leads) and prioritize the leads on the basis of these ratings and ranks.

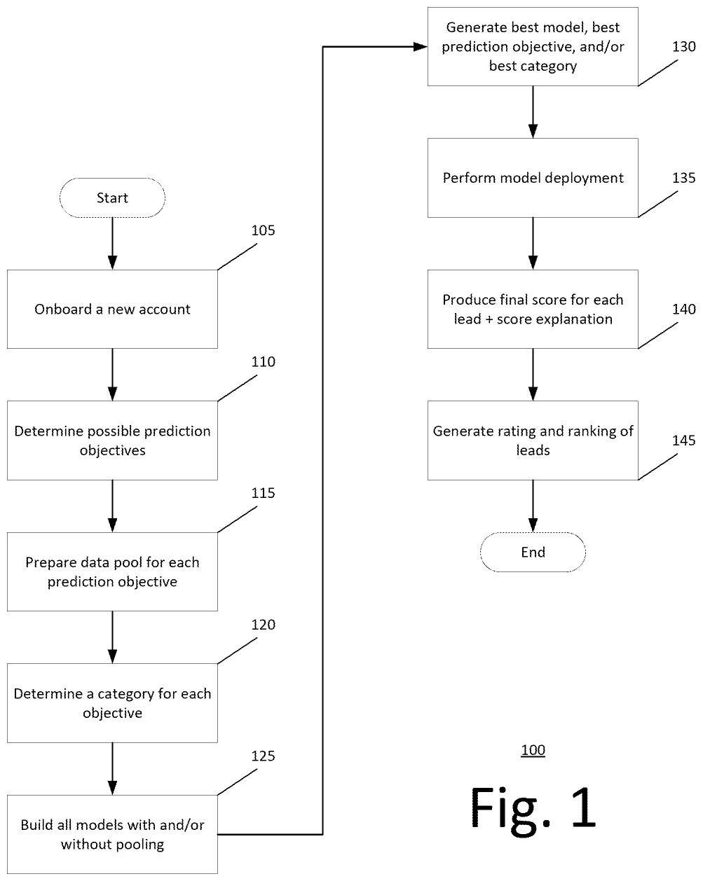

FIG. 1 is a flow diagram illustrating a method 100 for performing multi-tenant lead scoring on an end-to-end system, according to an embodiment of the present invention. In FIG. 1, method 100 includes onboarding a new account 105. This includes past lead data (if available), configured lead matching rules by the admin, etc. Method 100 further includes determining possible prediction objectives at 110, and for each prediction objective that is determined, preparing a data pool at 115.

Method 100 includes determining a category for each prediction objective on the basis of dependent variable (DV) or target variable (TV) and data available at 120. Method 100 further includes building all models with and without pooling at 125. This includes incorporating pooling and data enrichment processes. Method 100 continues with identifying the best model, best prediction objective, and the best category at 130.

Method 100 includes model deployment at 135, which includes several steps.

### Model Training and Metadata Generation Pipeline

This pipeline determines the best prediction objective by building different models for each new account and eventually produces a metadata comprising information about the final model, chosen prediction objective, performance, pooling flag, category, etc., for each account. The pipeline also stores the final production models in a S3 location.

### Copy Models to Production Sagemaker™ Machine

In some embodiments, a job is setup to copy and update the models, priors and metadata to the production environment for further use. This embodiment is executed after each training pipeline completion.

### Process Rules and Generate Weights to Each of the Models

In some embodiments, the explicit rules (configured by the admin) are consumed in each account and a weight is assigned to each rule using a mathematical algorithm.

### Prepare Payload Input for Online Prediction

Whenever a new lead payload (e.g., created/updates) comes into the production, the system prepares an input for online production. This includes data preparation, adding admin rules information with weights, etc. The system makes use of the metadata to find the correct model for the account.

The system may then invoke an online inference module to generate the lead prediction using fit/interest/email model. The system continues with generating percentile, rating and interpretability for each prediction. The system may also match and generate explicit rules base scores and eventually combines the ML score with it.

### Push Generated Score and Interpretability to Redis

The output of the online inference module is written to a Redis cluster which is used in product user interface (UI).

### Model Retraining

The system runs a daily job to retrain production models and priors for each account. Whenever there is a change in any accounts' model or priors, the system updates the same in the production and also makes the changes in the metadata accordingly.

Returning to FIG. 1, method 100 includes generating a final score for each lead and a message explaining the score at 140. Method 100 also includes generating a customer rating and ranking of leads at 145.

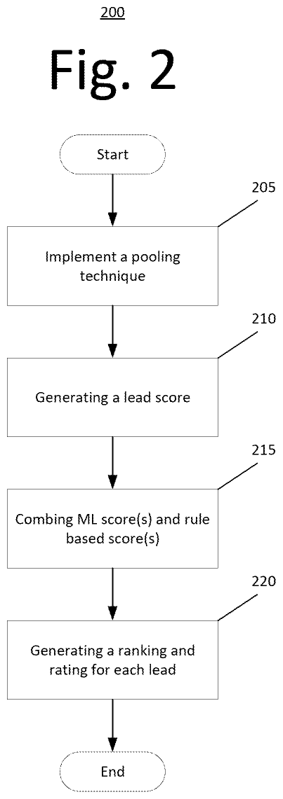

FIG. 2 is a flow diagram illustrating a method 200 for pooling and ranking of a set of leads, according to an embodiment of the present invention. In some embodiment, method 200 includes implementing a pooling technique enhancing and optimizing lead scoring machine learning techniques for a set of leads at 205, and generating a lead score for each configured rule at 210. The method also includes combining one or more machine learning (ML) scores and one or more rules based scores to create a unitary score for each corresponding lead in the set of leads at 215, and generating a rank and rating for each lead in the set of leads at 220.

The process steps performed in FIGS. 1 and 2 may be performed by a computer program, encoding instructions for the processor(s) to perform at least part of the process(es) described in FIGS. 1 and 2, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system to implement all or part of the process steps described in FIGS. 1 and 2, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components/modules of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A lead pooling and ranking system, comprising:
at least one processor; and
memory comprising a set of instructions, wherein
the set of instructions is configured to cause the at least one processor to execute
implementing a pooling technique enhancing and optimizing lead scoring machine learning techniques for a set of leads;
generating a lead score for each configured rule;
combining one or more machine learning (ML) scores and one or more rules based scores to create a unitary score for each corresponding lead in the set of leads; and
generating a rank and rating for each lead in the set of leads.

2. The system of claim 1, wherein the set of instructions is further configured to cause the at least one processor to execute
assigning a category to an entity for which a lead scoring feature is to be enabled, wherein the category comprises an indecisive tag, a blurry tag, and a limpid tag; and
determining if data pooling is required for an account based on the assigned category.

3. The system of claim 1, wherein the set of instructions is further configured to cause the at least one processor to execute
executing a ML based approach by combining a plurality of models and providing a single artificial intelligence (AI) score for each lead in the set of leads, wherein
the plurality of models comprises a fit model, an engagement model, and a semantic model.

4. The system of claim 1, wherein the set of instructions is further configured to cause the at least one processor to execute
executing a rules based approach by using an algorithm to automatically compute and assign different weights to each lead.

5. The system of claim 4, wherein the set of instructions is further configured to cause the at least one processor to execute
calculating a total weight to be assigned to each rule in the set of rules, wherein
the total weight is defined as
total_weight=min[MIN+max(#positive_rules,#negative_rules), MAX].

6. The system of claim 5, wherein the set of instructions is further configured to cause the at least one processor to execute
automatically computing a weight for each positive rule and each negative rule on a basis of a priority of each positive rule and each negative rule, wherein
the total calculated weight is distributed among a larger set of explicit rules, and
a weight assigned to k^{th} rules in the larger set of explicit rules is calculated as defined by
wₖ=w*k=2*k*total_weight*/[#LSR(#LSR+1)].

7. The system of claim 5, wherein the set of instructions is further configured to cause the at least one processor to execute
computing one or more weights for each of the configured rules, wherein
the computing of the one or more weights comprises
copying a smaller set of the explicit rules from weights of one or more individual assigned rules in the larger set of explicit rules.

8. The system of claim 1, wherein the set of instructions is further configured to cause the at least one processor to execute
matching a plurality of rules with a predefined attribute and calculating a matched score as defined in
sᵣ=(total matched positive weight−total matched negative weight).

9. The system of claim 8, wherein the set of instructions is further configured to cause the at least one processor to execute
generating the ML based score using a plurality of models as defined by
s_{ML}=(w₁*static_model_score)+(w₂*interest_model_score)+(w₃*semantic_model_score)
where, w₁, w₂, and w₃ are predetermined weights and represent the contributions from static, interest, and semantic models, respectively.

10. The system of claim 9, wherein the set of instructions is further configured to cause the at least one processor to execute
calculating the unitary score as defined by
s=s_{R}+s_{ML},s=s.clip(0,1).

11. A method for lead pooling and ranking, comprising:
implementing a pooling technique enhancing and optimizing lead scoring machine learning techniques for a set of leads;
generating a lead score for each configured rule;
combining one or more machine learning (ML) scores and one or more rules based scores to create a unitary score for each corresponding lead in the set of leads; and
generating a rank and rating for each lead in the set of leads.

12. The method of claim 10, further comprising:
assigning a category to an entity for which a lead scoring feature is to be enabled, wherein the category comprises an indecisive tag, a blurry tag, and a limpid tag; and
determining if data pooling is required for an account based on the assigned category.

13. The method of claim 10, further comprising:
executing a ML based approach by combining a plurality of models and providing a single artificial intelligence (AI) score for each lead in the set of leads, wherein
the plurality of models comprises a fit model, an engagement model, and a semantic model.

14. The method of claim 10, further comprising:
executing a rules based approach by using an algorithm to automatically compute and assign different weights to each lead.

15. The method of claim 14, further comprising:
calculating a total weight to be assigned to each rule in the set of rules, wherein
the total weight is defined as
total_weight=min[MIN+max(#positive_rules,#negative_rules), MAX].

16. The method of claim 15, further comprising:
automatically computing a weight for each positive rule and each negative rule on a basis of a priority of each positive rule and each negative rule, wherein
the total calculated weight is distributed among a larger set of explicit rules, and
a weight assigned to k^{th} rules in the larger set of explicit rules is calculated as defined by
wₖ=w*k=2*k*total_weight*/[#LSR(#LSR+1)].

17. The method of claim 15, further comprising:
computing one or more weights for each of the configured rules, wherein
the computing of the one or more weights comprises
copying a smaller set of the explicit rules from weights of one or more individual assigned rules in the larger set of explicit rules.

18. The method of claim 10, further comprising:
matching a plurality of rules with a predefined attribute and calculating a matched score as defined in
sᵣ=(total matched positive weight−total matched negative weight).

19. The method of claim 18, further comprising:
generating the ML based score using a plurality of models as defined by
s_{ML}=(w₁*static_model_score)+(w₂*interest_model_score)+(w₃*semantic_model_score)
where, w₁, w₂, and w₃ are predetermined weights and represent the contributions from static, interest, and semantic models, respectively.

20. The method of claim 19, further comprising:
calculating the unitary score as defined by
s=s_{R}+s_{ML},s=s.clip(0,1).
